(19) United States
(12) Patent Application Publication
(10) Pub. No.: US 2023/0274710 A1
(43) Pub. Date: Aug. 31, 2023

(54) METHOD FOR COMPENSATING DRIVING PARAMETERS FOR A DISPLAY AND CIRCUIT SYSTEM FOR THE SAME

(71) Applicant: REALTEK SEMICONDUCTOR CORP., HSINCHU (TW)

(72) Inventors: YUNG-CHIH CHEN, Hsinchu (TW); CHUN-YUAN SHIH, Hsinchu (TW)

(21) Appl. No.: 18/172,380

(22) Filed: Feb. 22, 2023

(30) Foreign Application Priority Data
Feb. 25, 2022 (TW) 111106926

(51) Int. Cl. G09G 3/34; G09G 3/32

(52) U.S. Cl. CPC G09G 3/3406; G09G 3/32; G09G 2320/0626; G09G 2310/0264; G09G 2320/0247; G09G 2320/0242; G09G 2320/0285

(57) ABSTRACT

A method for compensating driving parameters for a display and a circuit system for the same are provided. The method is performed in a backlight control circuit of a backlight module and a display driving circuit of a display panel of a display. A compensation parameter table is introduced. The compensation parameter table records compensation parameters applied to the backlight module and the display panel under different brightness and chrominance. When the backlight module and the display panel are in operation, the compensation parameters can be obtained by querying the compensation parameter table according to voltage and current values applied to the circuit system of the display. The backlight control circuit then outputs driving signals to each LED driving circuit according to the compensation parameters for each region. The display driving circuit outputs driving signals to display elements of the display panel according to the compensation parameters.

### CROSS-REFERENCE TO RELATED PATENT APPLICATION

This application claims the benefit of priority to Taiwan Patent Application No. 111106926, filed on Feb. 25, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure is related to a method for driving a display, and more particularly to a method and a circuit system for compensating driving parameters applied to a backlight module and a display panel of a display that suffers from uneven backlight brightness or chrominance.

### BACKGROUND OF THE DISCLOSURE

A backlight module of a display generally adopts mini light emitting diodes (mini LEDs) or micro light emitting diodes (micro LEDs) as the lighting elements, and one of the characteristics in the backlight module is that, the backlight module is able to conduct local dimming by controlling voltages and currents according to requirements. However, level differences of voltages and currents that are provided to control circuits for conducting local dimming in each of regions of the backlight module may result in problem of uneven brightness, specifically, the problem may be more evident under a low luminance.

The characteristics of the LEDs may inherently cause color shift problem to the backlight module when an image is displayed under a low luminance. A current solution introduces a common reference level signal among multiple LED driving circuits for mitigating the uneven brightness phenomenon due to the level differences of voltages and currents of the control circuits in the regions.

According to a conventional technology, only one set of calibration parameters provided to a specific backlight setting (generally set to a maximum brightness) is used as the calibration setting for addressing an unevenness problem of the backlight module when a global dimming operation is performed, and the conventional technology does not perform calibration based on difference brightness levels.

In another conventional technology, for a global dimming backlight module that has an LED backlight, only a portion having a specific brightness is divided into a plurality of regions and a brightness calibration table is established for each of the regions. When an LED backlight module is driven, the control circuit adjusts the voltages and currents applied to the LED backlight module according to the brightness calibration table. For the phenomenon of color shift occurring to the LED backlights under a low luminance, the LED driving circuit is used to control a precharge signal of the LEDs so as to produce an equivalent brightness by, for example, pulling higher currents or shortening a display time, for mitigating the color shift phenomenon.

### SUMMARY OF THE DISCLOSURE

The present disclosure is related to a method for compensating driving parameters for a display and a circuit system for the same. One of the technical purposes of the method is to provide solutions to address the problem that the conventional technology can only rely on compensation for the LED drivers of the backlight module to mitigate uneven backlight brightness and color shift problem of the local dimming backlight module under a low luminance due to the differences of control signals (e.g., currents) of regions. The method of the present disclosure provides multiple brightness and chrominance compensation parameter tables for different brightness ranges for compensating brightness and chrominance of each of the regions in order to mitigate the phenomenon of uneven brightness and chrominance.

The circuit system is applied to a display. The display includes a backlight module and a display panel. The circuit system includes a backlight control circuit of the backlight module and one or more light-emitting diode (LED) driving circuits. The one or more LED driving circuits are electrically connected with the backlight control circuit, and used to control operations of LEDs in each of the regions of the backlight module. The circuit system of the display also includes a display driving circuit of the display panel. The display driving circuit is able to separately control display elements of the display panel in each of the regions.

In one embodiment of the method for compensating driving parameters for a display, the method is performed in the circuit system in the display. A compensation parameter table is firstly established. In a process of establishing the compensation parameter table, a frame image that is inputted to the display is retrieved and divided into multiple regions, so as to obtain information of brightness and chrominance of each of the regions. After comparing the information of brightness and chrominance of each of the regions with a brightness reference value and a chrominance reference value, the brightness compensation parameters and the chrominance compensation parameters respectively applied to each of the regions of the display by the backlight control circuit and the display driving circuit can be calculated. The compensation parameter table is therefore established.

In the method for compensating driving parameters for a display, after the display is activated, e.g., powered on, a set of voltage and current values are inputted to the circuit system of the display. The circuit system can be the backlight control circuit. In the meantime, a compensation parameter table that records compensation parameters under different brightness is introduced. According to a brightness level obtained from a statistical result of a current image or a user setting, the set of voltage and current values inputted to the display can be obtained. After querying the compensation parameter table according to the brightness, the compensation parameters for the display are obtained. The compensation parameters are referred to for driving the display.

Preferably, the compensation parameter table records brightness compensation parameters applicable to the backlight module of the display and the chrominance compensation parameters applicable to a display panel of the display under different brightness levels. The method for compensating driving parameters for a display is adapted to a backlight control circuit of the display. The backlight control circuit outputs driving signals to an LED driving circuit for each of the regions of the backlight module according to the brightness compensation parameters. Therefore, unevenness of brightness among the regions of the backlight module can be calibrated. Further, the brightness compensation parameters in the compensation parameter table include pulse-width modulation (PWM) duty cycle, voltage, or current compensation values that are used to drive the one or more LED driving circuits in each of the regions of the backlight module.

Further, in the step of obtaining the brightness compensation parameters being inputted to the backlight control circuit according to the compensation parameter table, the historical compensation parameter data relating to the compensation parameters is referred to, furthermore, when the brightness compensation parameters that are dynamically modified and inputted to the backlight control circuit are obtained, the brightness compensation parameters that are currently operated in the backlight control circuit are considered, and a smooth operation is performed for avoiding a flickering problem that occurs when the backlight module switches the brightness compensation parameters.

Further, the method for compensating driving parameters for a display is applied to the display driving circuit of the display. The display driving circuit outputs the driving signals to the display elements of the display panel according to the chrominance compensation parameters, in which, according to information of brightness and chrominance for each of regions of the display, the chrominance compensation parameters in the compensation parameter table are introduced. Preferably, the chrominance compensation parameters are provided for the display driving circuit to control red, green and blue channel values of each of pixels of the display panel for calibrating unevenness of brightness and chrominance among the regions of the display panel.

The above-mentioned information of the brightness and the chrominance of each of the regions indicate characteristics of brightness and chrominance among the regions of the frame image being recorded with a color gamut curve, a brightness, and a brightness curve.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting a circuit system that performs a method for compensating driving parameters for a display according to one embodiment of the present disclosure;

FIG. 2 is a flowchart describing a process of establishing a compensation parameter table in the method for compensating driving parameters for a display according to one embodiment of the present disclosure;

FIG. 3 is a flowchart describing a process of dynamically modifying compensation parameters in the method for compensating driving parameters for a display according to one embodiment of the present disclosure;

FIG. 4 is a flowchart describing the method for compensating driving parameters for a display according to one embodiment of the present disclosure; and

FIG. 5 is a flowchart describing a process of generating the compensation parameters in the method for compensating driving parameters for a display according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure is related to a method for compensating driving parameters for a display and a circuit system. The method is performed in the circuit system in a display of an electronic device. The circuit system mainly includes a backlight module, a backlight control circuit, a display panel, and a display driving circuit of the display. The backlight control circuit is used to drive a light source in the backlight module. The light source of the backlight module can be implemented by using mini LEDs or micro LEDs. The display panel is such as a liquid-crystal display (LCD). The method and the circuit system are adapted to the backlight module that is capable of local dimming, and can be adapted to the backlight module that is capable of global dimming and that uses LEDs as the light source. One of the objectives of the method is to provide a solution to solve a problem of unevenness of brightness or chrominance of the backlight by compensating the driving parameters of the display. Further, with the local dimming backlight module as an example, the compensation solution can mitigate the problems of unevenness of brightness and color shift occurred to different regions of the backlight under a low luminance condition.

The uneven brightness and/or chrominance occurs to the different regions of the backlight under the low luminance condition mainly due to different driving parameters such as the voltages and the current outputted by the LED driving circuit to the different regions of the backlight. Accordingly, a brightness compensation parameter table and a chrominance compensation parameter table that are configured to be applied to the backlight control circuit and the display driving circuit, respectively, are designed for different brightness ranges, so that the backlight module and the display panel can be driven in regions according to the regional brightness information of the display. Therefore, the brightness and chrominance differences among the regions can be eliminated for achieving evenness of brightness and chrominance of the display.

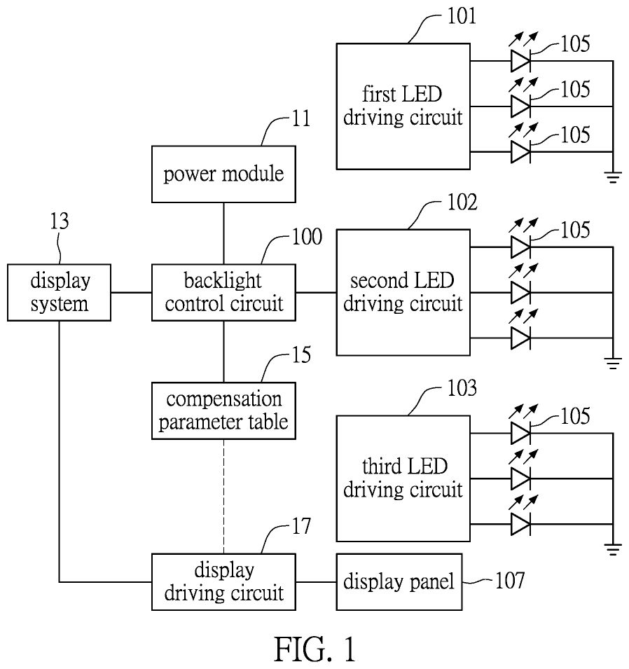

Reference is made to FIG. 1, which is a schematic diagram depicting the circuit system for performing the method for compensating driving parameters for a display according to one embodiment of the present disclosure. The circuit system includes a backlight control circuit 100 of the display. A backlight module of the display includes at least one LED driving circuit (101, 102 and 103) that is used to drive LEDs 105 in regions. Each of the LED driving circuits (101, 102 and 103) is electrically connected with the backlight control circuit 100. The circuit system also includes a display driving circuit 17 that is electrically connected with a display panel 107. The display panel 107 can be an LCD panel and the display driving circuit 17 is used to control a plurality of display elements of the display panel according to driving signals. The display element is such as a liquid crystal. The red, green and blue channel values of each of pixels of the display can be controlled by the display driving circuit 17.

According to one of the embodiments of the present disclosure, the backlight module includes a plurality of LEDs 105 that are arranged in an array. The plurality of LEDs 105 can be driven in regions based on local dimming requirements. In the diagram, multiple LED driving circuits such as a first LED driving circuit 101, a second LED driving circuit 102, and a third LED driving circuit 103 are provided. Each of the LED driving circuits controls the operations of the LEDs in different regions through electrical signals such as voltages and currents. The LEDs are driven to radiate a light having a specific brightness and a color temperature. The first LED driving circuit 101, the second LED driving circuit 102, and the third LED driving circuit 103 are controlled by a backlight control circuit 100. The backlight control circuit 100 controls the one or more LED driving circuits in a global dimming operation or a local dimming operation, according to a display requirement of the display system 13. A power module 11 can be controlled to supply electricity to the LEDs 105 via the one or more LED driving circuits (101, 102 and 103).

In the circuit system that performs the method for compensating driving parameters for the display, a memory is provided for storing a compensation parameter table 15 that is established according to brightness and chrominance measured in advance. The compensation parameter table 15 records brightness compensation parameters of the backlight module under different brightness levels, and chrominance compensation parameters of the display panel 107 under different brightness levels. For example, the brightness compensation parameters can be pulse-width modulation (PWM) duty cycle, or voltage or current compensation values that are used to drive the one or more LED driving circuits in each of the regions. The display driving circuit 17 outputs driving signals to display elements of the display panel 107 according to the chrominance compensation parameters so as to compensate brightness and chrominance for each of the regions of the display for reducing brightness and chrominance differences and mitigating a phenomenon of uneven brightness and chrominance among pixels.

When the display is activated, e.g., powered on, initial voltage and current values are inputted to the backlight control circuit of the display. The initial voltage and current values can be factory default values, user-setting values, or values determined for local dimming or global dimming operations. The backlight control circuit is operated according to the inputted voltage and current values. That is, when a brightness value reaches a low luminance so that the unevenness of brightness among multiple regions occurs, the voltage and current values inputted to backlight control circuit of the display is indicated to result in the differences of brightness and chrominance among the regions. Accordingly, the predetermined compensation parameter table is introduced.

The circuit system of the present disclosure includes a backlight control circuit 100 and a display driving circuit 17. The circuit system relies on the above conditions to conduct the compensation by introducing a compensation parameter table 15 from a memory of the circuit system. The compensation parameter table 15 records compensation parameters under different brightness and chrominance of the backlight module and the display panel. The circuit system obtains the brightness and chrominance compensation parameters corresponding the voltage and current values by querying the compensation parameter table 15 according to the current or the initial voltage and current values applied to the backlight module. Accordingly, the new compensated voltage and current values applied to the backlight control circuit 100 and the compensation parameters supplied to the display driving circuit 17 can be obtained. Afterwards, the backlight control circuit 100 outputs driving signals to the LED driving circuits (101, 102 and 103) in each of the regions of the backlight module according to the compensation parameters in each of the regions. In the meantime, the display driving circuit 17 introduces chrominance compensation parameters in the compensation parameter table, and the driving signals are accordingly outputted to the display elements of the display panel 107. In an exemplary example, the display parameters such as the red, green and blue channel values of each of the pixel of the display element are controlled in order to calibrate an unevenness of brightness and chrominance among the regions of the display panel 107. The display driving circuit 17 also outputs the driving signals to the display elements of the display panel 107 according to the chrominance compensation parameters.

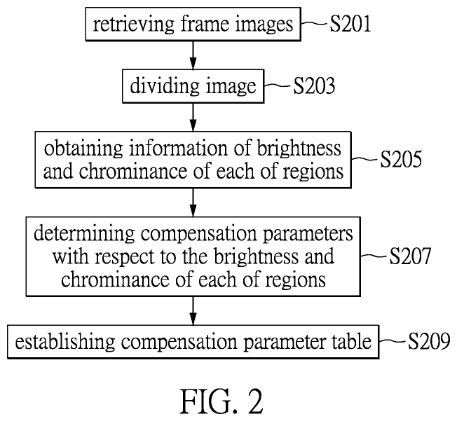

Reference is made to FIG. 2, which is a flowchart describing a process of establishing the compensation parameter table according to characteristics of the display in one embodiment of the present disclosure. The compensation parameter table essentially records the brightness compensation parameters under different brightness of the backlight module, and chrominance compensation parameters under different brightness of the display panel.

In the process, a frame image received by the display can be firstly obtained (step S201). Next, an area of a local dimming backlight module can be divided into multiple regions based on an arrangement of the multiple LEDs in regions (step S203). Information of brightness and chrominance of each of the regions can therefore be obtained (step S205). The information of brightness and chrominance of each of the regions can be the characteristics of brightness and chrominance among the regions of the frame image displayed on the display and being recorded under a color gamut curve, a brightness and a brightness curve. In the meantime, the information of brightness and/or the chrominance can be compared with a brightness reference value and/or a chrominance reference value being set based on a displaying requirement. Therefore, the compensation parameters with respect to brightness and chrominance for each of the regions can be determined (step S207) and the compensation parameter table is established (step S209). The compensation parameter table records brightness compensation parameters under different brightness of the backlight module of the display, and the chrominance compensation parameters under different brightness of the display panel of the display, furthermore, the compensation parameter table can be stored in a memory of the circuit system.

It should be noted that the brightness of each of the regions recorded in the compensation parameter table can be represented by a brightness grouping curve which describes the compensation parameters corresponding to different brightness ranges. The circuit system can refer to the brightness grouping curve for determining the compensation parameters of the brightness and chrominance for the backlight control circuit and the display driving circuit of the display, based on the brightness currently measured.

With a local dimming backlight module as an example, the brightness and chrominance of the local dimming backlight module can be measured under different brightness conditions. The plurality of groups of brightness and chrominance within different brightness ranges can be measured. In an aspect of the disclosure, the characteristics of brightness and chrominance with respect to a specific color gamut, a specific brightness, and a specific brightness curve for each of the regions of the display can be recorded in the memory of the circuit system. Further, the characteristics of the brightness and chrominance for the regions can be referred to for calculating the compensation values for every region of the display. The compensation parameters specified to the regions are then recorded in the compensation parameter table.

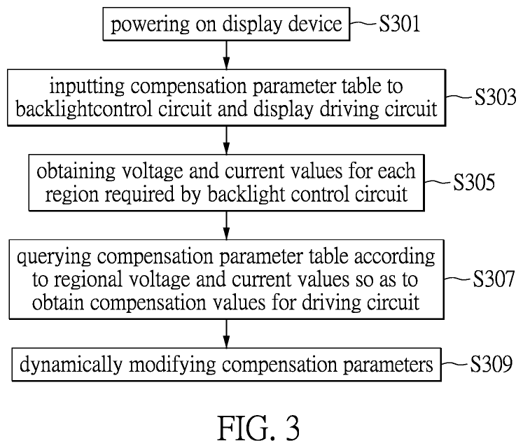

Accordingly, the brightness compensation parameters applied to the backlight control circuit or the chrominance compensation parameters applied to the display driving circuit can be obtained by querying the compensation parameter table according to brightness of each of the regions. In one further aspect of the disclosure, the compensation parameters can also be dynamically calculated by referring to characteristics of the display panel, the interaction influence among the regions, and/or the historical compensation parameter data specified to the display. Therefore, the compensation parameters applied to the backlight control circuit and/or the display driving circuit can be dynamically modified. Reference is made to FIG. 3, which is a flowchart describing a process of dynamically modifying compensation parameters in the method for compensating driving parameters for a display according to one embodiment of the present disclosure.

When the display device is powered on (step S301), the compensation parameters with respect to brightness and chrominance in the compensation parameter table are respectively applied to the backlight control circuit and the display driving circuit (step S303). Voltage and current values applied to each region and required by the backlight control circuit and the display driving circuit can be obtained according to a current picture or a user setting (step S305). Afterwards, the voltage and current values for each of the regions are referred to for querying the compensation parameter table. When the voltage and current values required by the backlight control circuit and the display driving circuit are obtained, the compensation values required by circuits of the display can be determined (step S307). It should be noted that a new set of voltage and current values after compensation required by the backlight control circuit and a set of compensation parameters required by the display driving circuit can be determined by querying the compensation parameter table according to the current voltage and current values inputted to the backlight control circuit.

The compensation parameters applied to the LED driving circuit of each of the regions can be obtained by querying the brightness compensation parameter table based on the information of brightness of the backlight module, and the corresponding voltage and current are then outputted to the LED driving circuits for the regions of the display. Further, the compensation parameters applied to the display elements of the display panel can also be obtained by querying the chrominance compensation parameter table, for example, for controlling the red, green and blue channel values of the pixels of the display panel. After that, the circuit system dynamically modifies the compensation parameters (step S309) for acquiring new compensation parameters by referring to the characteristics of the display panel, the interaction influence among the regions, and the historical compensation parameter data.

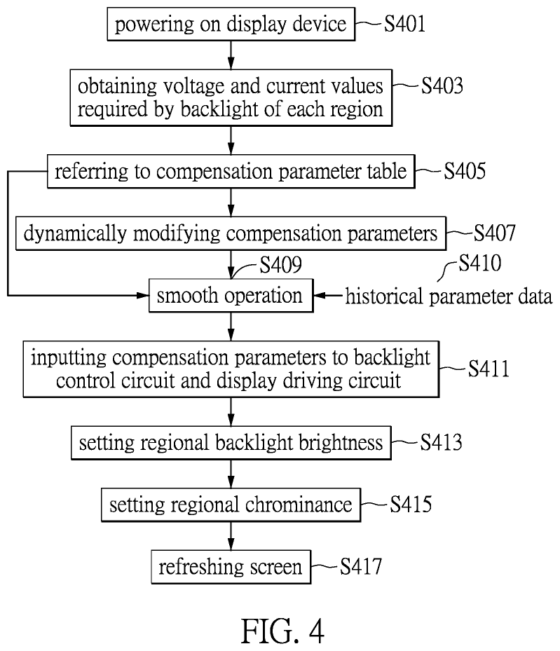

However, when the compensation parameters that are referred to for performing dynamic compensation upon the backlight control circuit and the display driving circuit are obtained, a flickering phenomenon may occur to the backlight module or the display panel when the compensation parameters are switched. According to one of the embodiments of the method for compensating driving parameters for a display, the current compensation parameters applied to the backlight control circuit (or including the display driving circuit) are considered, and a smooth operation is performed for avoiding the flickering phenomenon. Reference is made to FIG. 4, which is a flowchart describing the method according to one embodiment of the present disclosure.

In the beginning, a display device is powered on (step S401). The voltage and current values required by the backlight of each region according to a current picture or a user setting (step S403). The compensation parameters can be obtained by querying a compensation parameter table (step S405).

Alternatively, the compensation parameters can be modified dynamically based on a current situation, as shown in a process of FIG. 3 (step S407). In the meantime, the historical compensation parameter data can be referred to (step S410), and a smooth operation is performed when the new and old compensation parameters are switched (step S409). With the backlight module as an example, the compensation parameters adapted to the regions are selected based on a real-time calculation of changes of the backlight. The smooth operation is performed when both the new compensation parameters and the current compensation parameters are referred to. After the smooth operation, the new compensation parameters are applied to adjusting the brightness or the chrominance of the display for solving the flickering phenomenon occurring in the backlight module when switching the compensation parameters applied to the backlight control circuit. Next, the characteristics of the backlight module and the display panel, interactions among the pixels in each of the regions of the display, and the historical compensation parameter data are also taken into account for dynamically calculating a new set of compensation parameters. The new set of compensation parameters can be respectively inputted to the backlight control circuit and the display driving circuit (step S411). The brightness compensation parameters are referred to so as to set up regional backlight brightness of the backlight module (step S413), the chrominance compensation parameters are referred to so as to set up regional chrominance of the display panel (step S415), and the circuit system then refreshes the screen of the display (step S417).

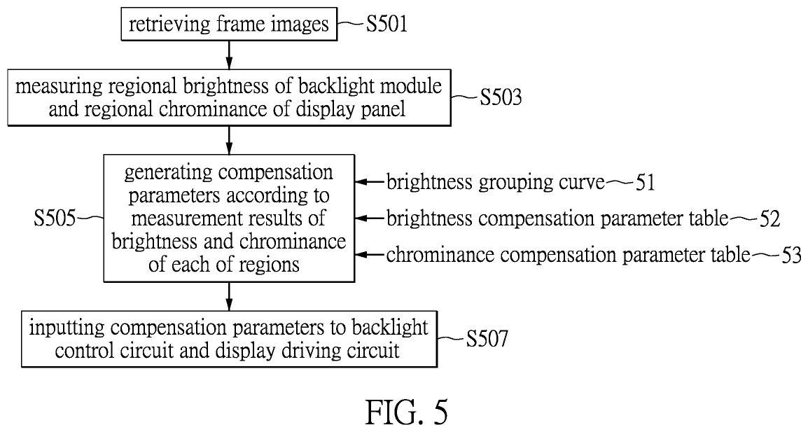

FIG. 5 is a flowchart describing a process of generating the compensation parameters in the method for compensating driving parameters for the display according to one embodiment of the present disclosure.

In the process of compensating the driving parameters of the display, the frame images are retrieved (step S501), and the regional brightness information of the LED in each region and regional chrominance information in each region can be obtained according to information of the frame images or the user setting (step S503). In the meantime, a compensation parameter table is introduced. In one embodiment of the present disclosure, the compensation parameters supplied to the backlight control circuit and the display driving circuit can be obtained after considering a brightness grouping curve 51, a brightness compensation parameter table 52, and a chrominance compensation parameter table 53 (step S505). In one further embodiment of the present disclosure, the process of dynamic compensation in FIG. 3 and the smooth operation performed when switching different compensation parameters in FIG. 4 can also be considered, and the compensation parameters are inputted to the backlight control circuit and the display driving circuit (step S507). The brightness compensation parameters applied to the regions of the backlight module form the voltage or current compensation values that are used to drive the backlight control circuit to output driving signals to the LED driving circuits of the regions. Accordingly, the brightness of the regions can be modified to be essentially consistent. Still further, the chrominance compensation parameters applied to the regions of the display panel are referred to for driving the display elements of the display, and acquiring chrominance calibration parameters for each of the regions. Thus, unevenness of brightness among the regions under low luminance can be calibrated by adjusting the brightness value of each of the regions of the local dimming backlight module, and unevenness of brightness and chrominance among regions under low luminance can be calibrated by adjusting the red, green and blue channel values of each of the pixels of the display panel.

It should be noted that the different compensation parameters can be switched according to a lookup table, and the compensation parameters can be switched once or switched in multiple stages. Further, since the compensation parameters corresponding to various brightness and being recorded in the compensation parameter table 53 are limited, an interpolation method can be used to acquire more accurate compensation parameters after obtaining the compensation parameters from the compensation parameter table 53.

For example, the compensation parameters obtained from the compensation parameter table can be electrical parameters that are provided by the backlight control circuit to the LED driving circuits of regions. The electrical parameters can be a PWM duty cycle, or currents that are used to drive the LEDs. Therefore, the red, green and blue channel values of pixels of the display panel can achieve the purpose of calibrating the unevenness of brightness and chrominance of regions of the display panel by adjusting the LEDs of the regions of the backlight module.

In conclusion, according to the above embodiments of the method for compensating driving parameters for a display and the circuit system for the same, the circuit system is able to provide various sets of brightness and chrominance compensation parameters with respect to different brightness ranges, in which a compensation parameter table is introduced and is established based on the measurements of brightness and chrominance of the backlight module and the display during a factory calibration phase. The compensation parameter table is stored in the circuit system of the display and can be used to compensate brightness and chrominance for regions of the backlight module and the display panel when the display is in operation. Therefore, unevenness of brightness and color shift of the LEDs can be eliminated when a local dimming display is under a low luminance.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for compensating driving parameters for a display, adapted to a circuit system of a display, the method comprising:
after the display is activated, inputting a set of voltage and current values to the circuit system;
introducing a compensation parameter table that records compensation parameters for the display under different brightness;
querying the compensation parameter table according to the set of voltage and current values for obtaining the compensation parameters for the display; and
the circuit system driving the display according to the compensation parameters.

2. The method according to claim 1, wherein the compensation parameter table records brightness compensation parameters of a backlight module of the display under different brightness, and chrominance compensation parameters of a display panel of the display under different brightness.

3. The method according to claim 2, wherein the method is applied to a backlight control circuit of the display, and the backlight control circuit outputs driving signals to one or more light-emitting diode (LED) driving circuits in each region of the backlight module according to the brightness compensation parameters for calibrating unevenness of brightness among the regions of the backlight module.

4. The method according to claim 3, wherein the brightness compensation parameters of the compensation parameter table include a pulse-width modulation (PWM) duty cycle and voltage or current compensation values that are used to drive the one or more LED driving circuits corresponding to each of the regions.

5. The method according to claim 4, wherein, for obtaining the brightness compensation parameters inputted to the backlight control circuit, historical compensation parameter data with respect to the display is referred to for dynamically modifying the brightness compensation parameters being inputted to the backlight control circuit.

6. The method according to claim 5, wherein, when the brightness compensation parameters that are dynamically modified and inputted to the backlight control circuit are obtained, the brightness compensation parameters that are currently operated in the backlight control circuit are considered, and a smooth operation is performed for avoiding a flickering problem that occurs when the backlight module switches the brightness compensation parameters.

7. The method according to claim 2, wherein the method is applied to a display driving circuit of the display, and the display driving circuit outputs driving signals to display elements of the display panel according to the chrominance compensation parameters.

8. The method according to claim 7, wherein, according to information of brightness and chrominance of each of regions of the display, the chrominance compensation parameters in the compensation parameter table are introduced for the display driving circuit to control red, green and blue channel values of each of pixels of the display panel for calibrating unevenness of brightness and chrominance among regions of the display panel.

9. The method according to claim 2, wherein the compensation parameter table is established by steps of:
retrieving a frame image that is inputted to the display;
dividing the frame image into multiple regions;
obtaining information of brightness and chrominance of each of the regions;
comparing the information of brightness and chrominance of each of the regions with a brightness reference value and a chrominance reference value, and respectively calculating the brightness compensation parameters and the chrominance compensation parameters of the backlight control circuit and a display driving circuit of the display applied to each of the regions; and
establishing the compensation parameter table.

10. The method according to claim 9, wherein the information of brightness and chrominance of each of the regions indicates characteristics of brightness and chrominance among the regions of the frame image being recorded under a color gamut curve, a brightness, and a brightness curve.

11. The method according to claim 9, wherein the compensation parameter table includes a brightness compensation parameter table and a chrominance compensation parameter table, wherein the backlight module is a local dimming backlight module, and the information of brightness of each of the regions is represented by a brightness grouping curve; wherein the brightness grouping curve is referred to for providing multiple sets of brightness compensation parameters for the backlight control circuit and multiple sets of chrominance compensation parameters for the display driving circuit based on different brightness ranges.

12. A circuit system, disposed in a display, comprising:
a backlight control circuit electrically connected with one or more light-emitting diode (LED) driving circuits of a backlight module of the display for controlling operations of multiple LEDs in each of regions of the backlight module;
a display driving circuit electrically connected with a display panel of the display for driving multiple display elements of the display panel;
wherein the circuit system performs a method for compensating driving parameters for the display, the method including:
after the display is activated, inputting a set of voltage and current values to the circuit system;
introducing a compensation parameter table that records compensation parameters for the display under different brightness;
querying the compensation parameter table according to the set of voltage and current values for obtaining the compensation parameters for the display; and
driving the display according to the compensation parameters.

13. The circuit system according to claim 12, wherein the circuit system further includes a memory that is used to store the compensation parameter table, and the compensation parameter table includes a brightness compensation parameter table and a chrominance compensation parameter table, wherein the backlight module is a local dimming backlight module, and information of brightness of each of the regions is represented by a brightness grouping curve.

14. The circuit system according to claim 13, wherein the compensation parameter table records brightness compensation parameters of a backlight module of the display under different brightness, and chrominance compensation parameters of a display panel of the display under different brightness.

15. The circuit system according to claim 14, wherein the backlight control circuit outputs driving signals to the one or more LED driving circuits in each region of the backlight module according to the brightness compensation parameters for calibrating unevenness of brightness among the regions of the backlight module.

16. The circuit system according to claim 14, wherein, according to information of brightness and chrominance of each of the regions of the display, the chrominance compensation parameters in the compensation parameter table are introduced for the display driving circuit to control red, green and blue channel values of each of pixels of the display panel for calibrating unevenness of brightness and chrominance among the regions of the display panel.

17. The circuit system according to claim 14, wherein, for obtaining the brightness compensation parameters inputted to the backlight control circuit, historical compensation parameter data with respect to the display is referred to for dynamically modifying the brightness compensation parameters being inputted to the backlight control circuit.

18. The circuit system according to claim 17, wherein, when the brightness compensation parameters that are dynamically modified and inputted to the backlight control circuit are obtained, the brightness compensation parameters that are currently operated in the backlight control circuit are considered, and a smooth operation is performed for avoiding a flickering problem that occurs when the backlight module switches the brightness compensation parameters.

19. The circuit system according to claim 12, wherein the compensation parameter table is established by steps of:
retrieving a frame image that is inputted to the display;
dividing the frame image into multiple regions;
obtaining information of brightness and chrominance of each of the regions;
comparing the information of brightness and chrominance of each of the regions with a brightness reference value and a chrominance reference value, and respectively calculating the brightness compensation parameters and the chrominance compensation parameters of the backlight control circuit and a display driving circuit of the display applied to each of the regions; and
establishing the compensation parameter table.

20. The circuit system according to claim 19, wherein the information of brightness and chrominance of each of the regions indicates characteristics of brightness and chrominance among the regions of the frame image being recorded under a color gamut curve, a brightness, and a brightness curve.
